(19) United States
(12) Patent Application Publication
(10) Pub. No.: US 2013/0310483 A1
(43) Pub. Date: Nov. 21, 2013

(54) METHOD OF PRODUCING A TREAD COMPOUND

(71) Applicants: Francesco Botti, Roma (IT); Veronica Cantonetti, Roma (IT); Davide Privitera, Anzio (RM) (IT)

(72) Inventors: Francesco Botti, Roma (IT); Veronica Cantonetti, Roma (IT); Davide Privitera, Anzio (RM) (IT)

(73) Assignee: BRIDGESTONE CORPORATION, Chuo-ku, Tokyo (JP)

(21) Appl. No.: 13/993,190

(22) PCT Filed: Dec. 23, 2011
(86) PCT No.: PCT/IB2011/055952

§ 371 Date: Aug. 2, 2013

(30) Foreign Application Priority Data
Dec. 23, 2010 (IT) TO2010A001054

(51) Int. Cl. C08L 9/06

(52) U.S. Cl. CPC C08L 9/06
USPC 523/156; 525/102

(57) ABSTRACT

A method of producing a rubber compound, which includes mixing at least one cross-linkable unsaturated-chain polymer base, silica, a first type of silane coupling agent, and a second type of silane coupling agent. The second type of silane coupling agent is added to the mix after the first type of silane coupling agent has reacted with the silica. The first type of silane coupling agent is a trialkoxymercaptoalkyl-silane, and the second type of silane coupling agent is a mercaptosilane protected in the form of thioester.

### TECHNICAL FIELD

The present invention relates to a method of producing a tread compound.

### BACKGROUND ART

As is known, part of the research carried out in the tyre industry is centred around improving tread performance in terms of wet road-holding and rolling and wear resistance.

Whereas these three characteristics can be improved individually, it is much more difficult to improve all three simultaneously, without improvement in one impairing one or both of the others. Also, improvement must be achieved without increasing the viscosity, and so impairing the workability, of the compound.

For this purpose, silica has long been used as a reinforcing filler in tread compounds, as a partial or total substitute for carbon black, because of the advantages it affords in terms of rolling resistance and wet road-holding performance.

Silica is used in combination with silane coupling agents, which bond with silanol groups to prevent the formation of hydrogen bonds between silica particles, and at the same time bond the silica chemically to the polymer base.

The advantages of octyl-oleate, in terms of cold-weather performance, and of combining low- and high-molecular-weight SBR polymers, in terms of abrasion resistance, have long been known.

The trialkoxymercaptoalkyl-silane class of silane coupling agents has proved particularly interesting, especially as regards the advantages it affords in reducing rolling resistance and volatile substance emissions.

The most effective compound has been found to be:

SH(CH₂)₃Si(OCH₂CH₃)(O(CH₂CH₂O)₅(CH₂)₁₃CH₃)₂

Used simultaneously, however, these ingredients fail to achieve the same improvement as when they are used individually. In particular, trialkoxymercaptoalkyl-silanes, while improving compounds in terms of rolling resistance and hydrocarbon emissions, may at the same time jeopardize improvements obtainable by other ingredients in terms of abrasion resistance.

A need is therefore felt for a method of producing tread compounds, designed to solve the problems of the known art.

The Applicant has surprisingly devised a method of producing tread compounds, designed to meet this demand.

### DISCLOSURE OF INVENTION

According to the present invention, there is provided a method of producing a rubber compound, comprising mixing at least one cross-linkable unsaturated-chain polymer base, silica, a first type of silane coupling agent, and a second type of silane coupling agent; said method being characterized in that said second type of silane coupling agent is added to the mix after said first type of silane coupling agent has reacted with said silica.

Preferably, said first type of silane coupling agent is a trialkoxymercaptoalkyl-silane, and said second type of silane coupling agent is a mercaptosilane protected in the form of thioester.

Preferably, said method comprises a first mixing step of mixing at least said cross-linkable unsaturated-chain polymer base, 50 to 250 phr of said silica, and 2 to 30 phr of said trialkoxymercaptoalkyl-silane; a second mixing step, in which 2 to 15 phr of said mercaptosilane protected in the form of thioester is added to the mix from said first mixing step; and a final mixing step, in which curing agents are added.

Preferably, said cross-linkable unsaturated-chain polymer base comprises 20 to 60 phr of an S-SBR polymer mix containing 25-45% styrene and 20-70% vinyl, and comprising 20-40% of a first fraction with a mean molecular weight of 50-100×10³ and a molecular weight distribution of ≦1.5, and 80-60% of a second fraction molecular weight distribution of ≦3.0.

Preferably, said cross-linkable unsaturated-chain polymer base also comprises 10 to 50 phr of E-SBR or S-SBR, and 0 to 20 phr of BR. S-SBR stands for styrene-butadiene rubber in solution, and E-SBR for styrene-butadiene rubber in emulsion.

Preferably, at least 2 phr of a plasticizing ester, preferably octyl-oleate, are added to the mix at said first mixing step.

Preferably, said trialkoxymercaptoalkyl-silane has the general formula (I)

R¹R²₂Si—R³—SH (I)

where:

R¹ represents a linear, cyclic or branched alkoxyl group with 1 to 8 carbon atoms; R² represents a linear, cyclic or branched alkoxyl group with 1 to 8 carbon atoms, or —O—(Y—O)m4-X (where Y represents a linear, cyclic or branched saturated or unsaturated divalent hydrocarbon group with 1 to 20 carbon atoms, X represents a linear, cyclic or branched alkyl group with 1 to 9 carbon atoms, and m4 represents a number of 1 to 40); and R³ represents a linear, cyclic or branched saturated or unsaturated alkylene group with 1 to 12 carbon atoms.

Preferably, said trialkoxymercaptoalkyl-silane is a trialkoxymercaptopropyl-silane.

Preferably, the trialkoxymercaptopropyl-silane has the general formula (II)

SH(CH₂)₃SiR⁴H⁵₂ (II)

where:

R⁴ is —OCH₂CH₃, and

R⁵ is —O(CH₂CH₂O)₅(CH₂)₁₃CH₃

Preferably, said mercaptosilane protected in the form of thioester has the general formula (III)

R⁶ₓR⁷_{y}R⁸_{z}SiR⁹SCOR¹⁰ (III)

where:

R⁶ represents an atom or a monovalent group selected from —Cl, —Br, R¹¹O—, R¹¹C(═O)O—, R¹¹R¹²C═NO—, R¹¹R¹²CNO—, R¹¹R¹²N— and —(OSiR¹¹R¹²)ₕ(OSiR¹¹R¹²H¹³), where R¹¹, R¹² and R¹³, which may the same or different, each represent a hydrogen atom or a monovalent hydrocarbon group with 1 to 18 carbon atoms, and h represents a number of 1 to 4; R⁷ is either the same as R⁶, or a hydrogen atom or a monovalent hydrocarbon group with 1 to 18 carbon atoms; R⁹ is either the same as R⁶ and/or R⁷, or a hydrogen atom or —[O(R¹⁴O)ⱼ]0.5, where R¹⁴ represents an alkylene group with 1 to 18 carbon atoms, and j represents an integer of 1 to 4; R⁹ represents a divalent hydrocarbon group with 1 to 18 carbon atoms; R¹⁰ represents a monovalent hydrocarbon group with 1 to 18 carbon atoms; and x, y and z represent integers satisfying the relations x+y+2z=3, 0≦x≦3, 0≦y≦2 and 0≦z≦1.

Preferably, the mercaptosilane protected in the form of thioester has the structural formula:

(CH₃CH₂O)₃Si(CH₂)₃SCO(CH₂)₆CH₃

### BEST MODE FOR CARRYING OUT THE INVENTION

The following are non-limiting examples for a clearer understanding of the present invention.

### EXAMPLES

Three control compounds (A-C) and a compound (D) in accordance with the teachings of the present invention were produced. More specifically, compound A is a standard tread compound of acknowledged satisfactory characteristics; compound B is a compound in which merely the ingredients individually affording particular advantages are added; and compound C is a compound in which the two types of silane coupling agents are added simultaneously to the mix.

Each compound was subsequently tested to assess wet road-holding and cold-weather performance, rolling and wear resistance, viscosity, and hydrocarbon emissions.

The example compounds described were produced as follows:

—First mixing step—

Before commencing the mixing operation, a 230-270-litre tangential-rotor mixer was loaded with the cross-linkable unsaturated-chain polymer base, the silica, the silane coupling agent, oil, carbon black, and stearic acid to a fill factor of 66-72%.

The mixer was operated at a speed of 40-60 rpm, and the resulting mix was unloaded on reaching a temperature of 140-160° C.

—Second mixing step—

The mix from the first step was mixed again in a mixer operated at 40-60 rpm, and was unloaded on reaching a temperature of 130-150° C. At this second mixing step, the second silane coupling agent was added to compound D.

—Third mixing step—

The curing system (sulphur, accelerants, antioxidants/antiozonants, zinc oxide) was added to the mix from the second step to a fill factor of 63-67%.

The mixer was operated at a speed of 20-40 rpm, and the resulting mix was unloaded on reaching a temperature of 100-110° C.

Table I shows the compositions in phr of the four compounds.

TABLE I

| | A | B | C | D |
|---|---|---|---|---|
| E-SBR | 70 | 35 | 35 | 35 |
| BR | 30 | 30 | 30 | 30 |
| LMW S-SBR | — | 35 | 35 | 35 |
| SILICA | 100 | 180 | 180 | 180 |
| SILANE | 10 | — | — | — |
| Trialkoxymercaptoalkyl- | — | 18 | 18 | 18 |
| silane | | | | |
| Mercaptosilane protected in | — | — | 8* | 8** |
| the form of thioester | | | | |
| OIL | 30 | 35 | 35 | 35 |
| Octyl-oleate | — | 15 | 15 | 15 |
| Carbon black | 10 | 10 | 10 | 10 |
| Stearic acid | 1 | 1 | 1 | 1 |
| Sulphur | 1.5 | 1.5 | 1.5 | 1.5 |
| Accelerants | 3.5 | 3.5 | 3.5 | 3.5 |
| Antioxidants/antiozonants | 3.5 | 3.5 | 3.5 | 3.5 |
| Zinc oxide | 2.5 | 2.5 | 2.5 | 2.5 |

*indicates the 8 phr of mercaptosilane protected in the form of thioester were added simultaneously with the trialkoxymercaptoalkyl-silane at the first mixing step.
**indicates the 8 phr of mercaptosilane protected in the form of thioester were added at the second mixing step.

LMW S-SBR is a rubber containing 25-45% styrene and 20-70% vinyl, and comprising:
20-40% of a first fraction with a mean molecular weight of 50-100×10³ and a molecular weight distribution of ≦1.5; and
80-60% of a second fraction with a mean molecular weight of 800-1500×10³ and a molecular weight distribution of ≦3.0.

SILICA is a commercial product marketed by RHODIA as 1115, and has a surface area of 110 m²/g.

SILANE is a commercial silane coupling agent marketed by DEGUSSA as S175.

The trialkoxymercaptoalkyl-silane is of formula (1).

The mercaptosilane protected in the form of thioester has the formula:

(CH₃CH₂O)₃Si(CH₂)₃SCO(CH₂)₆CH₃

The accelerants used are a mixture of MBTS, TBBS and DPG, and are the same for all the compounds.

The antioxidants/antiozonants used are the same for all the compounds.

As stated, compounds A-D were tested to assess wet road-holding and cold-weather performance, rolling and wear resistance, viscosity, and hydrocarbon emissions, and the results indexed with respect to compound A.

More specifically, E′ values were measured at −20° C. as per ASTM Standard D5992 to determine cold-weather performance, and TanD values were measured at different temperatures as per ASTM Standard D5992 to determine wet road-holding and rolling resistance.

Abrasion resistance was tested as per DIN Standard 516, and viscosity measured as per ASTM Standard D1646.

Table II shows the test results indexed with respect to compound A.

TABLE II

| | A | B | C | D |
|---|---|---|---|---|
| Wet road-holding (↑) | 100 | 110 | 110 | 110 |
| Cold-weather performance (↑) | 100 | 100 | 100 | 100 |
| Abrasion resistance (↑) | 100 | 95 | 100 | 100 |
| Rolling resistance (↑) | 100 | 108 | 100 | 108 |
| Viscosity (↓) | 100 | 125 | 100 | 100 |
| Hydrocarbon emissions (↓) | 100 | 60 | 70 | 70 |

(↑) indicates the higher the value the better the performance.
(↓) indicates the lower the value the better the performance.

As shown in Table II, the compound (D) produced using the method according to the invention provides for better overall improvement as compared with control compounds B and C.

The method of producing compound D by adding the two types of silane coupling agents in two different mixing steps represents a preferred embodiment of the invention, but does not exclude the possibility of the two types of silane coupling agents being added at different times in the same mixing step.

1. A method of producing a rubber compound, comprising mixing at least one cross-linkable unsaturated-chain polymer base, silica, a first type of silane coupling agent, and a second type of silane coupling agent; said method being characterized in that said second type of silane coupling agent is added to the mix after said first type of silane coupling agent has reacted with said silica.

2. A method of producing a rubber compound, as claimed in claim 1, characterized in that said first type of silane coupling agent is a trialkoxymercaptoalkyl-silane, and said second type of silane coupling agent is a mercaptosilane protected in the form of thioester.

3. A method of producing a rubber compound, as claimed in claim 2, characterized by comprising a first mixing step of mixing at least said cross-linkable unsaturated-chain polymer base, 50 to 250 phr of said silica, and 2 to 30 phr of said trialkoxymercaptoalkyl-silane; a second mixing step, in which 2 to 15 phr of said mercaptosilane protected in the form of thioester is added to the mix from said first mixing step; and a final mixing step, in which curing agents are added.

4. A method of producing a rubber compound, as claimed in claim 3, characterized in that said cross-linkable unsaturated-chain polymer base comprises 20 to 60 phr of an S-SBR polymer mix containing 25-45% styrene and 20-70% vinyl, and comprising 20-40% of a first fraction with a mean molecular weight of 50-100×10³ and a molecular weight distribution of ≦1.5, and 80-60% of a second fraction with a mean molecular weight of 800-1500×10³ and a molecular weight distribution of ≦3.0.

5. A method of producing a rubber compound, as claimed in claim 4, characterized in that said cross-linkable unsaturated-chain polymer base comprises 10 to 50 phr of E-SBR or S-SBR, and 0 to 20 phr of BR.

6. A method of producing a rubber compound, as claimed in claim 5, characterized in that at least 2 phr of a plasticizing ester are added to the mix at said first mixing step.

7. A method of producing a rubber compound, as claimed in claim 6, characterized in that said plasticizing ester is octyl-oleate.

8. A method of producing a rubber compound, as claimed in claim 2, characterized in that said trialkoxymercaptoalkyl-silane has the general formula (I)
R¹R²₂Si—R³—SH (I)
where:
R¹ represents a linear, cyclic or branched alkoxyl group with 1 to 8 carbon atoms; R² represents a linear, cyclic or branched alkoxyl group with 1 to 8 carbon atoms, or —O—(Y—O)m4-X (where Y represents a linear, cyclic or branched saturated or unsaturated divalent hydrocarbon group with 1 to 20 carbon atoms, X represents a linear, cyclic or branched alkyl group with 1 to 9 carbon atoms, and m4 represents a number of 1 to 40); and R³ represents a linear, cyclic or branched saturated or unsaturated alkylene group with 1 to 12 carbon atoms.

9. A method of producing a rubber compound, as claimed in claim 8, characterized in that said trialkoxymercaptoalkyl-silane is a trialkoxymercaptopropyl-silane.

10. A method of producing a rubber compound, as claimed in claim 9, characterized in that the trialkoxymercaptopropyl-silane has the general formula (II)
SH(CH₂)₃SiR⁴R⁵₂ (II)
where:
R⁴ is OCH₂CH₃, and
R⁵ is O(CH₂CH₂O)₅(CH₂)₁₃CH₃

11. A method of producing a rubber compound, as claimed in claim 2, characterized in that said mercaptosilane protected in the form of thioester has the structural formula (III)
R⁶ₓR⁷_{y}R⁸_{z}SiR⁹SCOR¹⁰ (III)
where:
R⁶ represents an atom or a monovalent group selected from —Cl, —Br, R¹¹O—, R¹¹C(═O)O—, R¹¹R¹²C═NO—, R¹¹R¹²CNO—, R¹¹R¹²N— and —(OSiR¹¹R¹²)ₕ(OSiR¹¹R¹²R¹³), where R¹¹, R¹² and R¹³, which may the same or different, each represent a hydrogen atom or a monovalent hydrocarbon group with 1 to 18 carbon atoms, and h represents a number of 1 to 4; R⁷ is either the same as R⁶, or a hydrogen atom or a monovalent hydrocarbon group with 1 to 18 carbon atoms; R⁸ is either the same as R⁶ and/or R⁷, or a hydrogen atom or —[O(R¹⁴O)ⱼ]0.5, where R¹⁴ represents an alkylene group with 1 to 18 carbon atoms, and j represents an integer of 1 to 4; R⁹ represents a divalent hydrocarbon group with 1 to 18 carbon atoms; R¹⁰ represents a monovalent hydrocarbon group with 1 to 18 carbon atoms; and x, y and z represent integers satisfying the relations x+y+2z=3, 0≦x≦3, 0≦y≦2 and 0≦z≦1.

12. A method of producing a rubber compound, as claimed in claim 11, characterized in that said mercaptosilane protected in the form of thioester has the structural formula:
(CH₃CH₂O)₃Si(CH₂)₃SCO(CH₂)₆CH₃

13. A tread compound, characterized by being produced using the method as claimed in claim 1.

14. A tread produced from a compound as claimed in claim 13.

15. A tyre comprising a tread as claimed in claim 14.
